(19) United States
(12) Patent Application Publication
(10) Pub. No.: US 2010/0137140 A1
(43) Pub. Date: Jun. 3, 2010

(54) Method And Substance For Promoting Plant Growth

(75) Inventor: Emil Golub, Hallandale, FL (US)

Correspondence Address: GOLD & RIZVI, P.A., 11555 Heron Bay Blvd., SUITE 200, Coral Springs, FL, 33076, US

(73) Assignee: MORVUS TECHNOLOGY LTD.

(21) Appl. No.: 12/518,323

(22) PCT Filed: Apr. 2, 2007
(86) PCT No.: PCT/US07/08173

§ 371 Date: Jun. 9, 2009

(51) Int. Cl. A01N 59/00; A01N 25/00; A01P 21/00

(52) U.S. Cl. 504/187; 504/116.1

(57) ABSTRACT

A method of stimulating growth and environmental stress resistance in a target plant is disclosed. An illustrative embodiment of the method includes providing a homeopathic growth stimulant, providing a dilution medium, diluting the homeopathic growth stimulant in the dilution medium to a level that molecules of the homeopathic growth stimulant are cloistered within a group of dilution medium molecules and are thereby rendered nontoxic and yet detectable to the plant to signal activation of defenses in the plant, providing a delivery medium comprising plant nutrients, combining the dilution medium and dissolved homeopathic growth stimulant with the delivery medium to form a plant enhancement substance and placing the plant enhancement substance in proximity to and into constituent communication with a target plant. A substance for promoting growth in a target plant is also disclosed.

### BACKGROUND OF THE INVENTION

1. Technical Field

The present invention relates to methods and compounds for promoting plant growth. More particularly, the present invention relates to plant growth enhancement substances and methods of employing these substances in order to promote plant growth, which includes applying a homeopathic growth stimulant and plant nutrients to target plants in order to induce growth-stimulating toxicity compensation responses in the plants.

2. Background Art

Plants have evolved complex natural defense mechanisms that enable them to cope with hostile elements in their environment. These natural defense mechanisms are usually activated when plants sense or detect the presence of stress signals. Plants can actively sense the presence of pathogens or other stress factors and stimulate the expression of certain genes (e.g., Hsp90, At-DBF2, etc.), particularly those encoding key enzymes in the phenylpropanoid pathway, which lead to the increased production of phenolic derivatives. Phenolics are a diverse group of plant secondary metabolites that are activated by a wide range of biotic and abiotic stresses. They are associated with a number of functions including UV-B protection and disease resistance as well as defense against herbivores, metal chelators and detrimental weather patterns.

Previous attempts have been made to enhance plant growth by treating plants with toxic substances. However, these toxic substances not only trigger growth-enhancing mechanisms but also produce offsetting negative toxic reactions in target plants such that an overall beneficial result is not attained. Furthermore, where negative reactions are minimized, any positive growth effects are minimized as well, or rendered negligible, because the prior methods do not meet the enhanced nourishment needs of a plant in which enhanced growth is triggered.

It is estimated that only ten percent of the Earth is suitable for agriculture, and most of this suitable surface area is currently in use. Fertilizers increase soil productivity; however, the relationship between the quantity of fertilizers and crop yield is exponential. Consequently, increasing the quantity of fertilizer beyond a certain point does not increase crop yield. By the same token, the addition of microelements, such as Cu, Mo, V and Mn, for example, can increase crop yield only under microelement deficit conditions. When all of the nutrients necessary for plant growth are present in soil, the crop yield is primarily dependent on weather conditions and seed quality.

Although there does exist a Plant Growth Hormone (PGH) that can stimulate plant growth, the cost of utilization of the hormone exceeds the financial gain resulting from the enhanced crop yield. Furthermore, PGH has exhibited considerable negative side effects on humans. Therefore, what is needed is a method and substance for stimulating plant growth and crop yield that is highly economical and safe to use.

### DISCLOSURE OF INVENTION

The invention is directed to a method of promoting plant growth, which includes the steps of preparing and combining a homeopathic dilution of a homeopathic growth stimulant having toxic substances with a nutrient-containing delivery medium to form a plant growth enhancing substance that stimulates plant growth and reproduction while conferring resistance to drought, heat and ultraviolet light exposure on treated plants.

In one aspect of the invention, a plant growth method and substance induces toxicity compensation responses in plants, such as an increase in osmotic adjustment, cell wall rheology, stress protean synthesis, stress hormone (i.e., abscisic acid) synthesis, polyamine synthesis, and consequential and accompanying increases in crop yield, relative to plants treated with fertilizer only, and confers on treated plants an increase in resistance to drought, frost, salinity, flood, heat, wind and ultraviolet light exposure. Furthermore, the substance and method confer an increase in concentration of crop sugar and protein, an increase in the quality of crop as planting material for subsequent years, an increase in cation exchange capacity of the soil as a result of fertility, and an increase in inhibition of microbial respiratory denitrification of the soil.

In another aspect of the invention, the plant growth method and substance favorably influence the effects of microbes in the soil and of nitrogen-fixing microorganisms on the plant root system (i.e., Rhizobia) for plant growth by inhibiting metal-containing enzymes and reductases, and stimulating metal-containing oxidizes.

In another aspect of the invention, the plant growth method and substance are safe for plants because it does not induce the negative effects of a toxicity compensation response such as arrested growth, low crop yield, denitrification of soil, low nitrogen uptake and, in some instances, plant death.

In another aspect of the invention, the plant growth method and substance are nontoxic to humans and most animals, and highly economical to practice and to provide on a scale sufficiently large to treat many acres of crops at a time.

These and other aspects, features, and advantages of the present invention will become more readily apparent from the attached drawing and the detailed description of the preferred embodiments, which follow.

### BRIEF DESCRIPTION OF THE DRAWINGS

The preferred embodiments of the invention will hereinafter be described in conjunction with the appended drawing provided to illustrate and not to limit the invention, where like designations denote like elements, and in which:

FIG. 1 is a flow diagram illustrating an embodiment of the method of promoting plant growth.

### MODES FOR CARRYING OUT THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

The present invention is generally directed to a method and substance for promoting plant growth, which includes applying a homeopathic growth stimulant and plant nutrients to target plants in order to induce a growth-stimulating toxicity compensation response in the plants. The method includes the use of a homeopathic growth stimulant, typically a transition metal such as Cu, Mo or V, for example, mixed with fertilizers in a concentration that is sufficient to induce toxic stress without causing toxic effects in the target plants. The method is economical, safe and amenable to large-scale application to a variety of plants and crops.

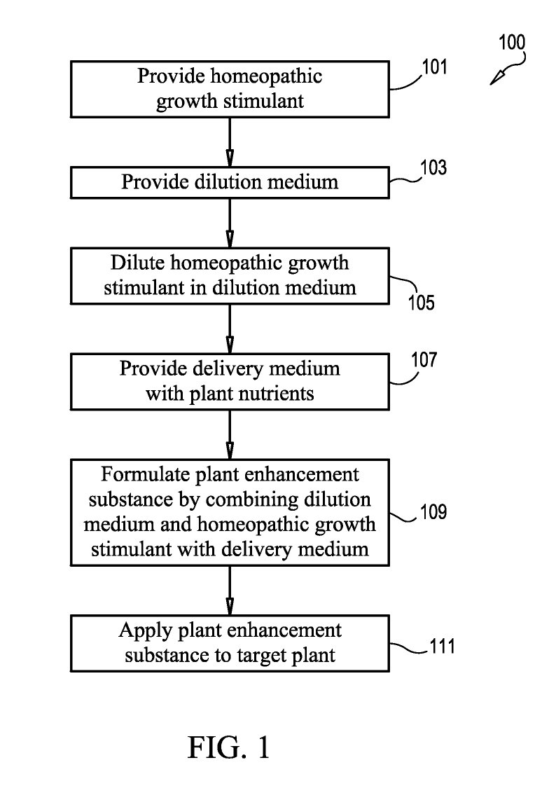

Referring to the flow diagram 100 illustrated in FIG. 1, a homeopathic method of stimulating plant growth and reproduction and conferring resistance to drought, heat and ultraviolet (UV) light exposure on a target plant is illustrated. The method includes initially providing a homeopathic growth stimulant, as indicated in block 101. The homeopathic growth stimulant may be provided in the form of a plant toxic substance, such as a transition metal or metals, for example. In block 103, a dilution medium, such as water or a water/alcohol mixture, for example, is provided. In block 105, the homeopathic growth stimulant is diluted in the dilution medium to a concentration at which molecules of the homeopathic growth stimulant are rendered nontoxic and yet remain detectable to a target plant to which the resulting substance will ultimately be applied, and therefore, signal activation of plant defenses or toxicity compensation responses to toxin-related stress in the target plant. In block 107, a delivery medium containing plant nutrients such as a fertilizer is provided. In block 109, a novel plant enhancement substance is formulated by combining and mixing the dilution medium and dissolved homeopathic growth stimulant with the delivery medium. In block 111, the plant enhancement substance is applied to a target plant by placing the plant enhancement substance in constituent (toxin and nutrient) communication with the target plant.

As a result of applying the plant enhancement substance to the target plant according to the method, plant defenses to toxins or toxicity compensation responses are triggered in the target plant. Compared to control plants, these plant defenses or responses generally result in more robust and stockier plant growth, higher rates of reproduction, and enhanced resistance to detrimental environmental conditions. Higher rates of plant reproduction are achieved because one defense to toxins involves the creation of a greater number of female parts (such as flowers) relative to male parts (such as pollen) on a plant. Therefore, the plant enhancement substance provides both toxin-induced stimulation for plant growth and the nourishment that is necessary to facilitate such growth.

The homeopathic growth stimulant in block 101 of the flow diagram 100 is typically a plant toxic substance. The plant toxic substance may be a transition metal. As used herein, a transition metal may be any element in the d-block of the Periodic Table of the Elements, corresponding to groups 3-12 of the Periodic Table. Examples of transition metals suitable for use as the homeopathic growth stimulant include, but are not limited to, copper, molybdenum, vanadium, or any combination thereof. In the homeopathic growth stimulant, the transition metal may be formulated as a metal salt, such as copper sulfate pentahydrate (CuSO₄.5H₂O), for example.

The dilution medium in block 103 of the flow diagram 100 is typically water or an alcohol-water mixture. The required dilution of the homeopathic growth stimulant in the dilution medium is believed to be the point at which atoms or molecules of the homeopathic growth stimulant are cloistered within a group of dilution medium molecules. Accordingly, water defines three-dimensional structures (i.e., cloisters) with hydrogen bonds around each dissolved transition metal atom. At such a concentration, the homeopathic growth stimulant is rendered nontoxic to a target plant and yet is sufficiently potent to induce a toxicity compensation response in the plant.

Homeopathic dosages are based on principles of serial dilution, and homeopathic products are marketed in strengths that indicate the number of dilutions that the substance has undergone in the manufacturing process. Homeopathic products are marketed with either “X” or “C” potencies. “X” potencies are prepared by 1 to 10 dilutions, and “C” potencies are prepared by 1 to 100 dilutions. For example, a mercury compound is completely dissolved in solvent/diluent in a ratio of 1 part of mercury compound to 10 parts or 100 parts solution. The resulting solution in known as the 1X or 1C dilution. To manufacture the 2X or 2C dilution, one (1) part of the 1X solution is mixed with nine (9) parts solvent/diluent and one (1) part of the 1C solution is mixed with ninety-nine (99) parts of the solvent/diluent. This dilution

Typically, dilution of the homeopathic growth stimulant in the dilution medium, as set forth in block 105, involves dilution of the transition metal salt or other homeopathic growth stimulant about 3-12X potency. It has been found that CuSO₄, in high concentration, arrests root development but in homeopathic concentration (3-12X potency) acts as a root growth enhancer. Homeopathy involves gradually diluting a toxic substance, and thus decreasing its potency, to the point at which the substance virtually disappears but remains within molecule clusters.

The delivery medium with plant nutrients in block 107 of the flow diagram 100 is typically a fertilizer, which may be wet, dry or a combination of wet and dry fertilizers. In block 109, the plant enhancement substance, which will ultimately be applied to the target plant, is formulated by combining the homeopathic growth stimulant/dilution medium mixture obtained in block 105 with the delivery medium. In the case of a liquid fertilizer, the homeopathic growth stimulant, which is typically a homeopathic solution of a transition metal salt or salts, is added to the liquid fertilizer to a suitable concentration that is adequate to induce a desired level of stress defense reaction or toxicity compensation response, and concomitant plant growth, in a target plant. In an illustrative embodiment, the homeopathic growth stimulant/dilution medium mixture is provided in correlation with one homeopathic lactose pellet or 0.05 ml 3-12X Cuprum Sulphuricum alcohol-water solution per liter or kilogram of fertilizer.

In the case of a solid, dry fertilizer, chunks of the fertilizer can be provided with a mineral oil or ether coating to prevent agglutination of the chunks. The homeopathic growth stimulant/dilution medium mixture, typically in gaseous form, is placed in contact with the coated or non-coated fertilizer chunks for a sufficient time and at a sufficient concentration that a suitable quantity of the cloistered transition metal molecules from the homeopathic growth stimulant/dilution medium mixture are absorbed by the coating or directly by the fertilizer.

In block 111, the plant enhancement substance is applied to the target plant and/or to the soil in which the target plant grows. The plant enhancement substance is placed in constituent communication with the target plant. This typically involves spraying of the plant enhancement substance on the target plant and/or soil using any of a variety of techniques and equipment known by those skilled in the art.

As was noted herein above, homeopathy involves gradual dilution of a toxic substance to a concentration at which the substance virtually disappears although chemical constituents and properties of the substance remain within molecule cloisters. When those chemical constituents and properties are transferred to carriers (such as fertilizers) which are more stable than water, such as sugar, alcohol, mineral oil or other hydrogen-containing carrier, the resulting homeopathic remedy has biological activity which is opposite the biological activity of the prime substance.

During consecutive dilutions of the homeopathic growth stimulant with the dilution medium in block 105, molecules of CuSO₄ disappear whereas cloistered individual copper atoms that retain their chemical properties remain in solution. The chemical properties of the copper atoms are later transferred to the fertilizer with which the cloistered copper atoms are combined in block 109. In the present case, fertilizers play the role of carrier due to a large quantity of hydrogen-bearing chemicals in solution. The present method promotes plant growth through application of fertilizers in combination with homeopathically prepared salts of transition metals to plants.

Research on the efficacy of the method of the present invention has been conducted on baby corn seeds due to the rapid response to the plant enhancement substance that the seeds exhibit. The length of roots that developed on the baby corn seeds, after treatment of the seeds with various concentrations of homeopathic growth stimulant, was measured. It was found that higher concentrations of CuSO₄ in the homeopathic growth stimulant arrest root growth, whereas lower concentrations of CuSO₄ in the homeopathic growth stimulant, below the homeopathic barrier or threshold concentration, enhance root growth. This critical transition indicates a fundamental difference in the chemical structure of the resulting plant enhancement substance by molecular cloistering. The criticality and creation of a chemically different substance brought about by dilution is indicated by the synergy of combining the resulting dilution medium and dissolved homeopathic growth stimulant with a nutrient source such as a fertilizer. This synergy is evidenced by the multiplication of growth increase in target plants resulting from the combination. Treatment of a target plant using the dilution medium and the dissolved homeopathic growth stimulant only results in the doubling of plant growth. Treatment of a target plant with only a nutrient source such as a fertilizer also results in the doubling of plant growth. However, treatment of a target plant using a combination of dilution medium and dissolved homeopathic growth stimulant along with a nutrient source increases plant growth tenfold.

According to the invention, through action of the plant enhancement substance, heavy metal toxicity creates a chain of events in plants, symbiotic nitrogen-fixing microorganisms and soil, leading to growth enhancement and crop yield increases. Heavy metals accumulate in roots by a 9:1 margin, preventing their transport to the shoot. Metal toxicity in plants increases the size of root systems and decreases the size of the aboveground portion of the plant, since in the case of actual metal toxicity a plant selects survival behavior instead of productivity behavior. However, if the plant is not afflicted with metal toxicity, as in the case of the method of the present invention, the plant enhancement substance merely induces a toxicity compensation response in the target plant; therefore, crop productivity increases due to larger root systems, a healthier and stronger plant and increased crop yield. Furthermore, a large root system increases the quantity of nitrogen-fixing microorganisms that exist in symbiosis with the plant, and consequently, increases nitrogen uptake that leads to additional crops.

Some types of soil bacteria, such as Alcaligenes xylosoxidans (AxNiR) and Alcaligenes faecalis S-6 (AfNiR), for example, can grow anaerobically by utilizing nitrogen compounds such as nitrates as an alternative to oxygen. This microbial respiratory process is known as denitrification, since nitrate (NO₃) is taken up by the bacteria from soil and subsequently reduced in a series of reactions: NO₃-NO₂-NO—N₂O—N₂. Nitrate reductases (NiRs) are the key enzymes of denitrification. During denitrification, however, significant irreversible losses of fixed nitrogen from the soil to the atmosphere occur.

Nitrate reductases (NiRs) are the key enzymes of denitrification. There are two types of NiRs: one in which Cu is the coenzyme and the other in which haeme groups are the coenzyme. In the case of the first type of NiR, the addition of homeopathic Cu to soil with fertilizer according to the method of the present invention inhibits NiR function due to the Homeopathic Law of opposite reactions: dilution of the Cu in the homeopathic growth stimulant with the dilution medium to a point which is beyond the homeopathic barrier causes inhibition rather than stimulation of NiR activity. Consequently, loss of nitrogen from the soil to the atmosphere during denitrification is minimized.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalence.

What is claimed is:

1. A method of stimulating growth and environmental stress resistance in a target plant, comprising:
providing a homeopathic growth stimulant;
providing a dilution medium;
diluting said homeopathic growth stimulant with said dilution medium to a level that molecules of said homeopathic growth stimulant are cloistered within a group of molecules of said dilution medium and are thereby rendered nontoxic and yet detectable to the target plant to induce a toxicity compensation response in the target plant;
providing a delivery medium comprising plant nutrients;
combining said dilution medium and said homeopathic growth stimulant with said delivery medium to form a plant enhancement substance; and
placing said plant enhancement substance into constituent communication with the target plant.

2. The method of claim 1 wherein said homeopathic growth stimulant comprises a plant toxic substance.

3. The method of claim 2 wherein said plant toxic substance comprises a transition metal.

4. The method of claim 3 wherein said transition metal comprises at least one of copper, molybdenum and vanadium.

5. The method of claim 3 wherein said transition metal is provided as a component of a metal salt.

6. The method of claim 5 wherein said metal salt comprises copper sulfate.

7. The method of claim 1 wherein said dilution medium comprises water.

8. The method of claim 1 wherein said delivery medium comprises a fertilizer.

9. The method of claim 8 wherein said fertilizer comprises at least one of a wet fertilizer and a dry fertilizer.

10. A method of stimulating growth and environmental stress resistance in a target plant, comprising:
providing a homeopathic growth stimulant;
providing a dilution medium;
diluting said homeopathic growth stimulant with said dilution medium to about 3-12X homeopathic potency;
providing a delivery medium comprising plant nutrients;
combining said dilution medium and said homeopathic growth stimulant with said delivery medium to form a plant enhancement substance; and
placing said plant enhancement substance into constituent communication with the target plant.

11. The method of claim 10 wherein said homeopathic growth stimulant comprises a plant toxic substance.

12. The method of claim 11 wherein said plant toxic substance comprises a transition metal.

13. The method of claim 12 wherein said transition metal comprises at least one of copper, molybdenum and vanadium.

14. The method of claim 12 wherein said transition metal is provided as a component of a metal salt.

15. The method of claim 14 wherein said metal salt comprises copper sulfate.

16. The method of claim 10 wherein said dilution medium comprises water.

17. The method of claim 10 wherein said delivery medium comprises at least one of a wet fertilizer and a dry fertilizer.

18. A substance for promoting growth in a target plant, comprising:
a dilution medium;
a homeopathic growth stimulant diluted with said dilution medium to a level that molecules of said homeopathic growth stimulant are cloistered within a group of molecules of said dilution medium and are thereby rendered nontoxic and yet detectable to the target plant to induce a toxicity compensation response in the target plant; and
a delivery medium comprising plant nutrients combined with said dilution medium and said homeopathic growth stimulant to form a plant enhancement substance.

19. The substance of claim 18 wherein said homeopathic growth stimulant is diluted with said dilution medium to about 3-12X potency.

20. The substance of claim 18 wherein said homeopathic growth stimulant comprises a transition metal.
